(19) United States
(12) Patent Application Publication
(10) Pub. No.: US 2020/0111129 A1
(43) Pub. Date: Apr. 9, 2020

(54) Dynamic Proponent Targeting Based on User Traits

(71) Applicant: International Business Machines Corporation, Armonk, NY (US)

(72) Inventors: Trudy L. Hewitt, Cary, NC (US); Jonathan Dunne, Dungarvan (IE); Jeremy A. Greenberger, San Jose, CA (US); Shadi Albouyeh, Raleigh, NC (US)

(21) Appl. No.: 16/153,250

(22) Filed: Oct. 5, 2018

(51) Int. Cl. G06Q 30/02; G06Q 10/06; G06Q 50/00

(52) U.S. Cl. CPC G06Q 30/0269; G06Q 10/067; G06Q 30/0254; G06Q 30/0214; G06Q 50/01

(57) ABSTRACT

An approach is provided in which an information handling system creates a class model of a user based on analyzing a set of social media data corresponding to the user and extracted from a social media network. Next, the information handling system matches the class model to a set of product data corresponding to a product. Then, in response to matching the class model to the set of product data, the information handling system sends a request to the user to promote the business on the social media network.

### BACKGROUND

Social media are computer-mediated technologies that facilitate the creation and sharing of information, ideas, career interests and other forms of expression via virtual communities and social networking services. Users typically access social media services via web-based technologies on desktops and laptops, or download services that offer social media functionality to their mobile devices (e.g., smartphones and tablets).

When engaging with these services, users create highly interactive platforms through which individuals, communities, and organizations share, co-create, discuss, and modify user-generated content or pre-made content posted online. Some social media sites have a greater potential for posted content to spread “virally” over social networks. In a social media context, content or websites that are “viral” (or which “go viral”) are those with a greater likelihood that users reshare content posted by another user to their own social network, leading to further sharing.

Given the growing popularity of social media outlets and the marketing potential of users with the most followers, businesses benefit from leveraging the social media outlets to advertise their products and/or services. A challenge found, however, is that businesses do not have a mechanism that identifies criteria that leads to viral messages and, in turn, advertising exposure to a large number of individuals.

### BRIEF SUMMARY

According to one embodiment of the present disclosure, an approach is provided in which an information handling system creates a class model of a user based on analyzing a set of social media data corresponding to the user and extracted from a social media network. Next, the information handling system matches the class model to a set of product data corresponding to a product. Then, in response to matching the class model to the set of product data, the information handling system sends a request to the user to promote the business on the social media network.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting an agent management engine identifying a select group of social media users as candidate agents for a business based on comparing the social media users' attributes against the business's brand characteristics;

FIG. 4 is an exemplary diagram depicting an agent management engine 300 analyzing designated agents' social media messages against business product characteristics;

FIG. 5 is an exemplary diagram depicting potential agent user data collect by and analyzed by the agent management engine;

FIG. 6 is an exemplary high-level flowchart showing steps taken to select designated agents to promote a business' product or service;

FIG. 7 is an exemplary flowchart showing steps taken to evaluate users that are selected as potential agents for a business; and

FIG. 8 is an exemplary flowchart showing steps taken to select designated agents and subsequently monitor their social media activity.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

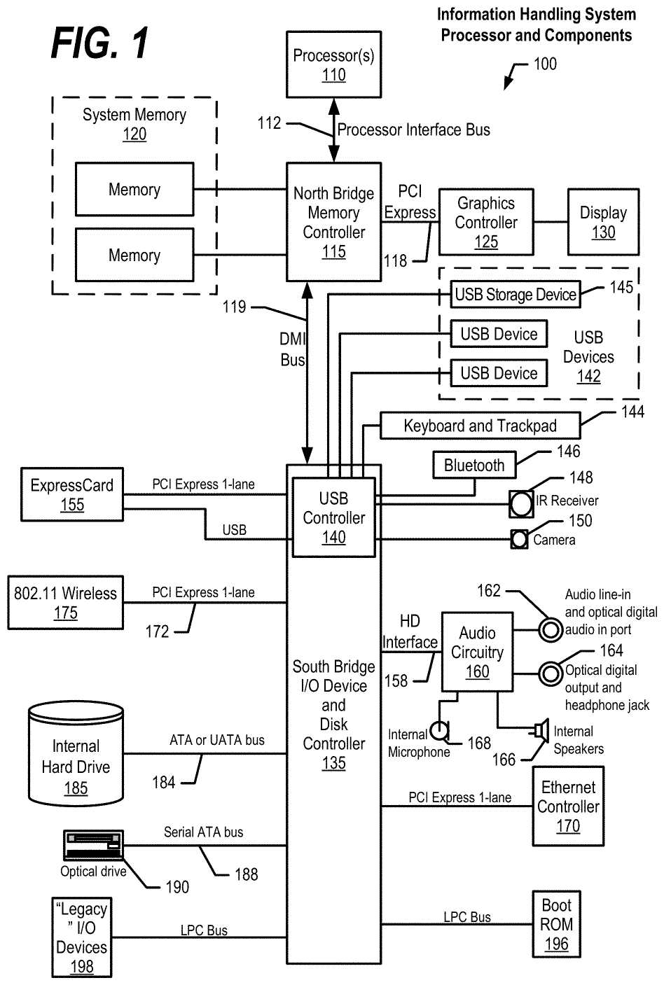

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

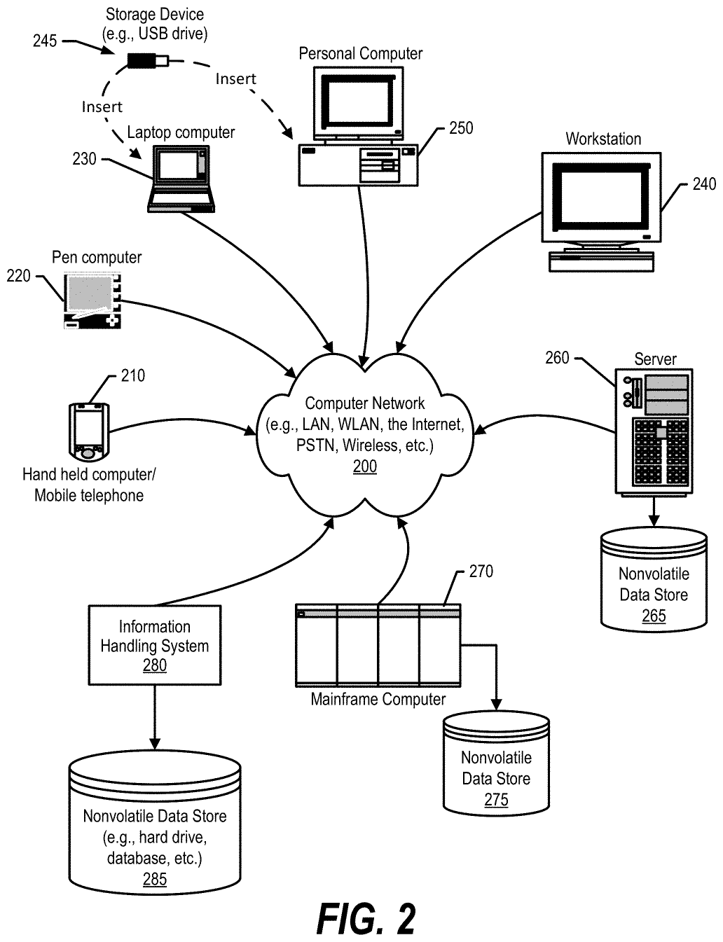

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

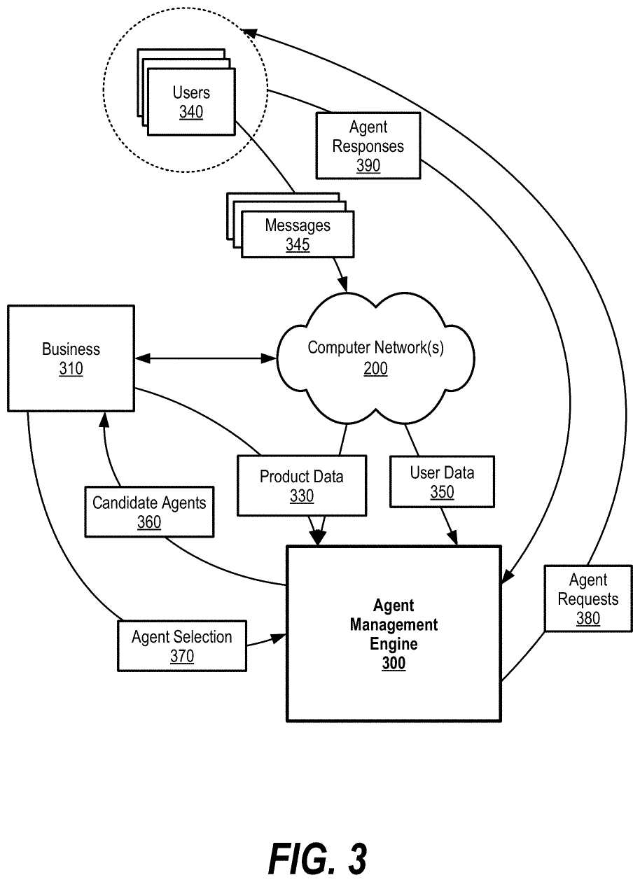

FIGS. 3 through 8 depict an approach that can be executed on an information handling system to connect businesses with users who are deemed popular on social media to become designated agents of the business and promote the businesses' brands, products, goods, and services.

In one embodiment, the information handling system accurately identifies traits to the user's popularity and correlates the traits with the appropriate product, services, etc., to find the right business to alert for advertisement potential. In another embodiment, a user may possess a certain physical or other characteristic(s) that have made them popular (teeth, hair, fashion sense, athletic ability) which is prominent in their online profile. In this embodiment, the information handling system correlates the user's physical characteristics to related businesses, such as correlating a user with long hair to a shampoo company.

The information handling system not only determines precisely who on social media would be a good candidate to advertise certain goods/services, but also provides a mechanism to act upon this information and pursue individuals for advertising purposes.

FIG. 3 is an exemplary diagram depicting an agent management engine identifying a select group of social media users as candidate agents for a business based on comparing the social media users' attributes against the business's brand characteristics.

Agent management engine 300 captures product data 330 from business 310 and from computer networks 200. Product data 330 informs agent management engine 300 about business 310's brand, which business 310 manually provides or agent management engine 300 extracts from computer networks 200. For example, business 310 may identify qualities or characteristics of users that should be measured, such as “Great Hair”, “Great Smile”, “Over 2000 Followers”, “Has Influence in the United States.”

Additionally, agent management engine 300 allows advertisers the flexibility to decide what they are and are not interested in and to what extent certain parameters must match the desired criteria. For example, business 310 may instill a rule of “do not alert me until X number of likes are hit because of XYZ product” or, rather than giving a specific number, the rule may indicate that a page needs a certain percentage increase of followers.

In another embodiment, based on historical behaviors/activity of thresholds which are selected by business 310, agent management engine 300 learns and dynamically implements/suggests new thresholds. In this embodiment, threshold trending could be pooled and eventuated based on industry trends and business can determine whether or not to implement thresholds based on industry historical data analysis. The same concepts could be applied for business 310 to evaluate the selected user(s) to determine if business 310 would want to be affiliated with that person. (i.e. matches company's values)

Business 310 then requests agent management engine 300 to identify candidate agents from users 340 that would represent their brand the best, taking into account the criteria they have provided.

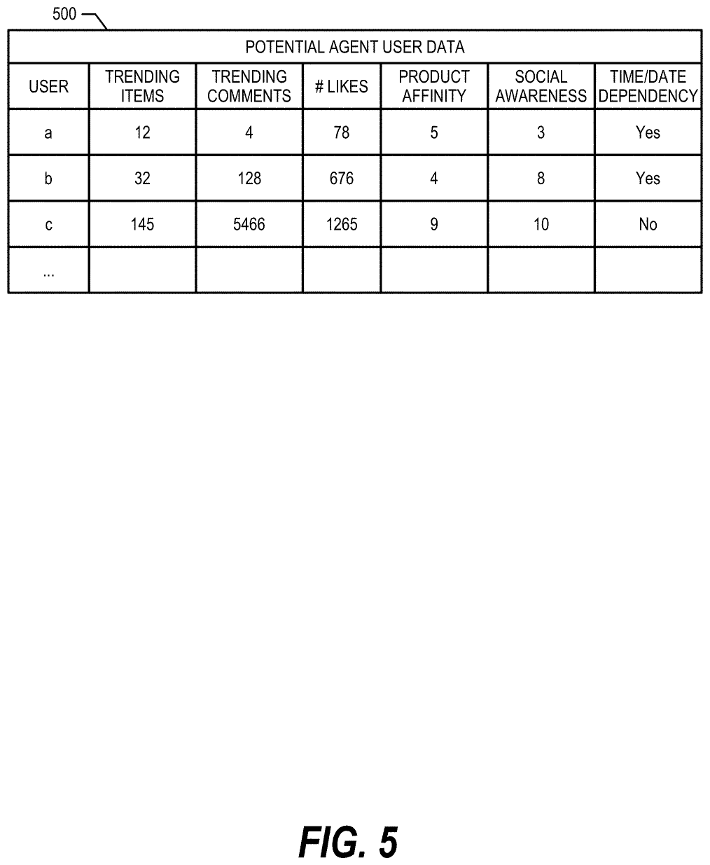

Agent management engine 300 captures user data 350, which is based on messages 345 generated by users 340. Agent management engine 300 analyzes user data 350 and identifies users corresponding to trending items, trending comments, number of likes, product affinity, social awareness, etc. (see FIG. 5 and corresponding text for further details). In one embodiment, to determine an underlying reason for a user's popularity, agent management engine 300 uses a combination of:
Image/Text/Comments processing (Which items are being posted)
Comments (What is discussed in the posts)
Time/date context (Whether the company is selling a seasonal item that people are discussing; e.g. Christmas product)
Number of likes
Number of followers
Product affinity (Whether the person tends to favor a brand of products over another in his/her posts)
Social Awareness (purchase preference based on how/where products are produced, ingredients, etc.)

Next, agent management engine 300 determines an optimal collection of users to represent business 310 using approaches such as:
Determine individuals with number of followers that match business 310's predetermined threshold of interest
Via image processing or text processing (depending on whether images or texts that are being reviewed), determine with level of confidence the types of images and posts the user often shares
Scan images to determine the images' constituent parts while building a class mode to collect the elements of each image.
Via sentiment/tone analysis, analyze the number of likes on a category of images that are deemed prominent to a user's profile and correlate those with comments associated with posts to determine whether the content is being positively or negatively received by the network.
Combine the class model with a timeliness of emotive feedback to infer which image elements or post topics are currently trending in which social cohorts.
Aggregate the respective information to determine with some level of confidence the best likely candidates to share with businesses to represent their product, brand, service, etc.

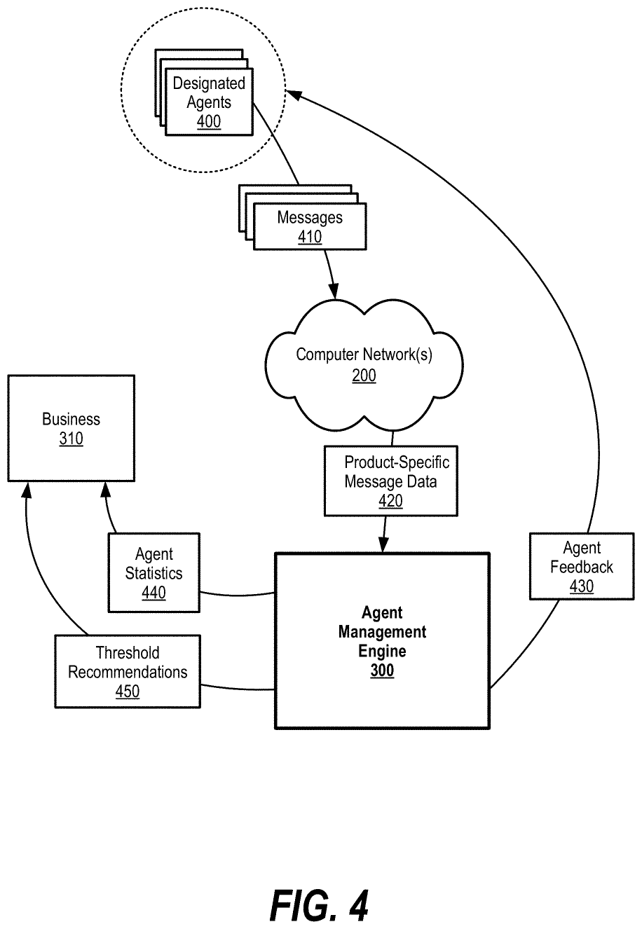

Agent management engine 300 then shares the optimal collection of users (candidate agents 360) with business 310. Business 310, in turn, provides agent selection 370 to agent management engine 300 and agent management engine 300 sends requests to the selected agents (agent requests 380) asking whether they are interested in being designated agents of business 310. Agent management engine 300 receives agent responses 390 from users 340 indicating acceptance/rejection. In turn, agent management engine 300 assigns a set of designated agents to business 310 and monitors their activity accordingly (see FIG. 4 and corresponding text for further details).

FIG. 4 is an exemplary diagram depicting an agent management engine 300 analyzing designated agents' social media messages against business product characteristics. Agent management engine 300 captures product-specific message data 420 corresponding to messages 410 that, in one embodiment, is a subset of messages 410. Agent management engine 300 analyzes product-specific message data 420 against business 310's criteria and provides feedback to designated agents 400 on what to promote/how to promote the product or service (agent feedback 430). For example, Bob is a designated agent of XYZ Hair products because Bob was identified to have great hair. When Bob is notified he has been selected to represent XYZ hair products, Bob is informed why he was selected, such as “Bob, you were selected to represent XYZ because you have been identified to have great hair!” Now, Bob has more context on how he should represent the brand.

In one embodiment, if Bob chooses not to be a designated agent for XYZ hair products, agent management engine 300 creates a historical reference for products, etc. that Bob is willing to be an agent and creates affiliations as needed.

Agent management engine 300 also provides agent statistics 440 to business 310, which may include a list of the top five designated agents receiving positive feedback from promoting business 310's products/services. Agent management engine 300 also provides threshold recommendations 450 based on the analysis. In one embodiment, threshold recommendations 450 are customized by users or automatically detected and sent by agent management engine 300. In this embodiment, threshold recommendations 450 are based on the priority and interest of business 310 and are also specific to the designated agent.

FIG. 5 is an exemplary diagram depicting potential agent user data collect by and analyzed by the agent management engine. Table 500 includes examples of potential agent user data collected by agent management engine 300. As those skilled in the art can appreciate, more, less, and/or different data may be collected than what is shown in FIG. 5. Potential agent user data includes trending items by a user, trending comments by a user, and number of likes (total or per item/comment). Agent management engine 300 may also generate product affinity scores and social awareness scores on, for example, a 0-10 scale. Agent management engine 300 may also determine whether a particular user's messages have a time/date dependency, such as a user discussing real-time topics versus a user having more permanent discussion topics (hair color, etc.).

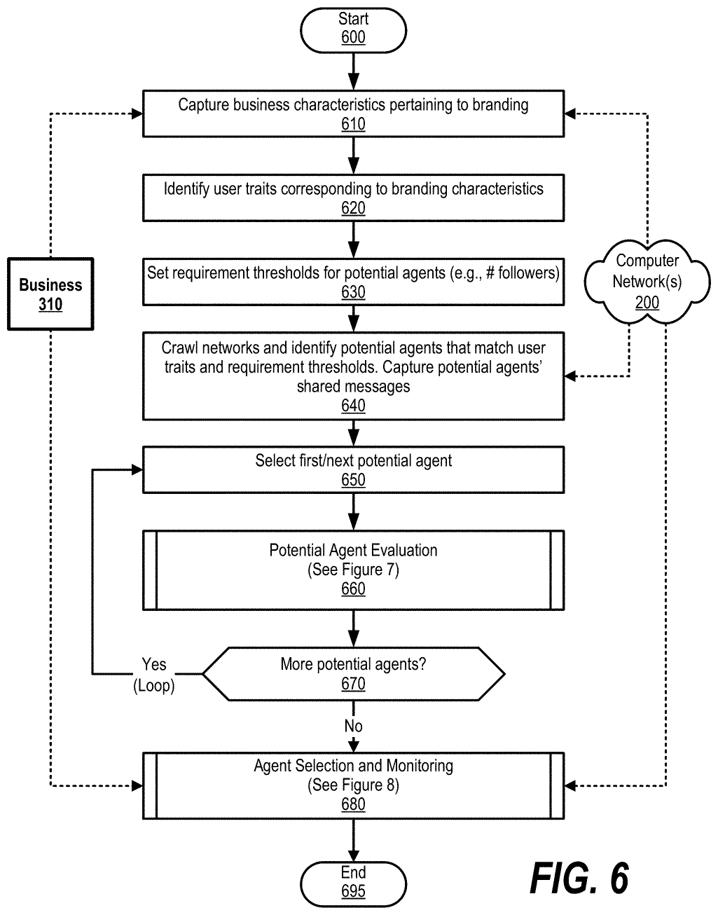

FIG. 6 is an exemplary high-level flowchart showing steps taken to select designated agents to promote a business' product or service. FIG. 6 processing commences at 600 whereupon, at step 610, the process captures branding characteristics (business characteristics) pertaining to the business' brand, such as their type of product/service, their overall business brand attributes (wholesome, edgy, reliable, etc.). At step 620, the process identifies preferred user traits corresponding to the branding characteristics (e.g., clean cut, long hair, tall, etc.).

At step 630, the process sets requirement thresholds for potential agents (e.g., # followers), which may be provided by business 310 or a predetermined default level or percentage. At step 640, the process crawls computer networks 200 and identifies potential agents that have user traits matching the business characteristics and meet the requirement thresholds.

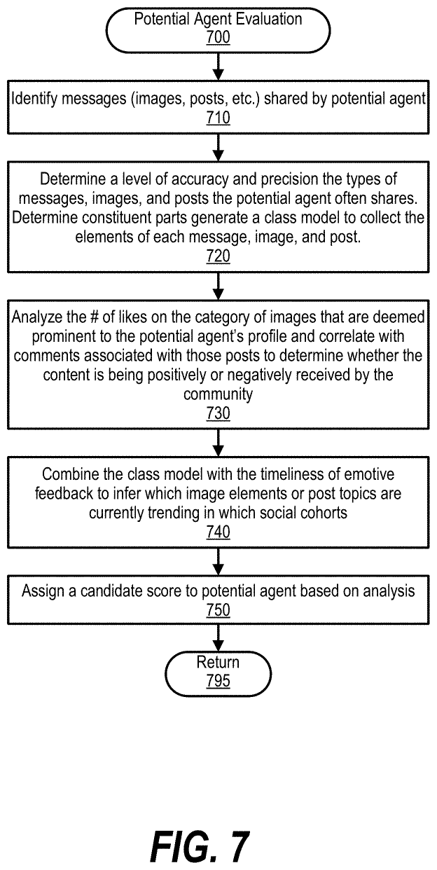

At step 650, the process selects the first potential agent and, at predefined process 660, the process evaluates the potential agent against business characteristics and assigns candidate scores accordingly to rank the potential agents (see FIG. 7 and corresponding text for processing details). The process determines as to whether there are more potential agents to evaluate (decision 670). If there are more potential agents, then decision 670 branches to the ‘yes’ branch which loops back to select and evaluate the next potential agent. This looping continues until there are no more potential agents to evaluate, at which point decision 670 branches to the ‘no’ branch exiting the loop.

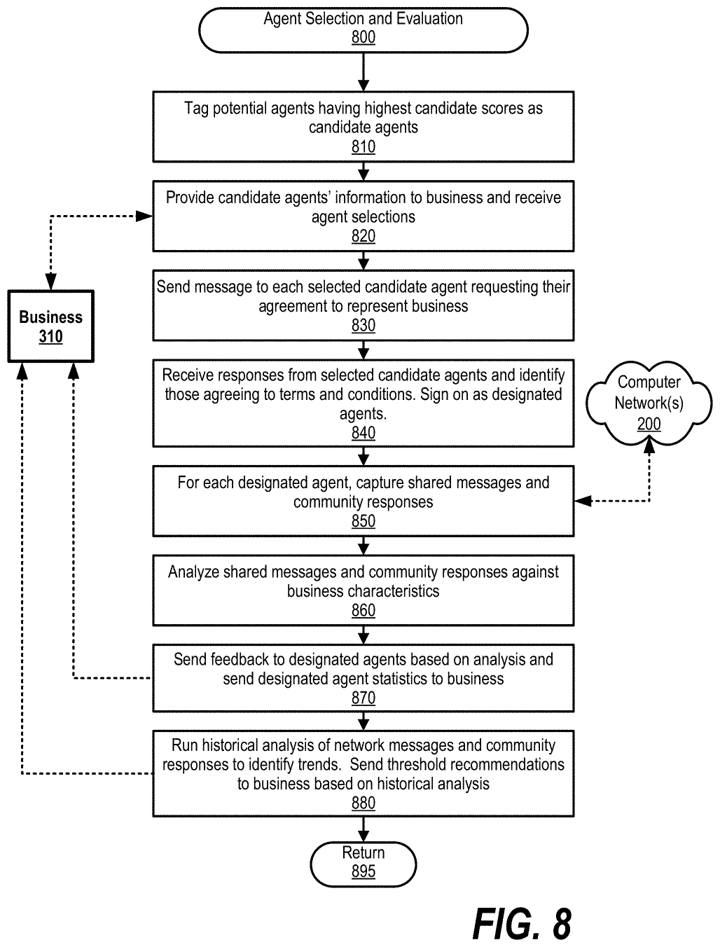

At predefined process 680, the process, with business 310's input, selects the top candidate agents as designated agents and monitors their social media activity for benefit to the company (see FIG. 8 and corresponding text for processing details). FIG. 6 processing thereafter ends at 695.

FIG. 7 is an exemplary flowchart showing steps taken to evaluate users that are selected as potential agents for a business. FIG. 7 processing commences at 700 whereupon, at step 710, the process identifies messages (images, posts, etc.) shared by the potential agent. At step 720, the process determines a level of accuracy and precision that the types of messages images and posts the potential agent often shares. The process determines constituent parts and builds a class model to collect the elements of each image and message.

At step 730, the process analyses the number of likes on the category of images that are deemed prominent to the potential agent's profile and correlates them with comments associated with the posts to determine whether the content is being positively or negatively received by the community. At step 740, the process combines the class model with the timeliness of emotive feedback to infer which image elements or post topics are currently trending in which social cohorts. In other words, the process takes into consideration the speed in which potential agents get responses when posts are made on social media. For example, a well-known celebrity has a higher “timeliness” of responses compared to Joe Smith so the process leverages the parameter in comparison to the class model.

At step 750, the process assigns a candidate score to the selected potential agent based on the analysis in step 750. In one embodiment, the candidate score may be based on pre-defined criteria or customized based on the intent of a group/channel (e.g., klout score). FIG. 7 processing thereafter returns to the calling routine (see FIG. 6) at 795.

FIG. 8 is an exemplary flowchart showing steps taken to select designated agents and subsequently monitor their social media activity. FIG. 8 processing commences at 800 whereupon, at step 810, the process tags potential agents having highest candidate scores (from FIG. 7 steps) as candidate agents. For example, the process identifies the top 10 candidate agents with the highest score. In one embodiment, the process identifies a first set of candidate agents to represent a first subset of business characteristics and identifies a second set of candidate agents to represent a second subset of business characteristics, especially of the business has a wide breadth of products/services.

At step 820, the process provides candidate agents' information to business 310 and receives agent selections from business 310. At step 830, the process sends a message to each selected candidate agent requesting their agreement to represent business and terms/conditions, such as monetary payments. At step 840, the process receives responses from the selected candidate agents and identifies those agents agreeing to the terms and conditions. The process assigns these candidate agents as designated agents for business 310.

At step 850, for each designated agent, the process captures shared messages and community responses over time. For example, once a user is a designated agent, the process may monitor the user's social media posts and track posts pertaining to business 310's products/services.

At step 860, the process analyzes the shared messages and community responses against business characteristics. At step 870, the process sends feedback to the designated agents based on the analysis and sends statistics to business 310. At step 880, the process runs historical analysis of network messages and community responses to identify trends. For example, when the process identifies a digital influencer (user with a substantial amount of followers) that posted positive remarks for a particular product or brand, the process notifies the company for that product/brand (manually or automated).

The process sends threshold recommendations to business based on historical analysis, and FIG. 8 processing thereafter returns to the calling routine (see FIG. 6) at 895.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
creating, by the processor, a class model of a user based on analyzing a set of social media data corresponding to the user and extracted from a social media network;
matching, by the processor, the class model to a set of product data corresponding to a product; and
in response to matching the class model to the set of product data, sending, by the processor, a request to the user requesting the user to promote the product on the social media network.

2. The method of claim 1 wherein, prior to creating the class model, the method further comprises:
capturing branding characteristics of a business corresponding to the product;
determining a set of preferred user traits corresponding to the branding characteristics; and
identifying a set of potential agents that match the set of preferred user traits, wherein the set of potential users comprises the user.

3. The method of claim 2 further comprising:
in response to identifying the set of potential agents, capturing a set of shared messages corresponding to the set of potential agents;
identifying a subset of the set of shared messages that correspond to the user; and
utilizing at least the subset of the shared messages as the set of social media data to create the class model.

4. The method of claim 1 further comprising:
receiving a response from the user agreeing to one or more terms included in the request, wherein at least one of the one or more terms is a monetary payment to the user to promote the product; and
designating the user as an agent to a business corresponding to the product.

5. The method of claim 4 wherein, in response to designating the user as an agent to the business, the method further comprises:
collecting subsequent messages corresponding to the user;
analyzing the subsequent messages against a set of branding characteristics of the business; and
sending one or more promotion recommendations to the user based on the analysis.

6. The method of claim 5 further comprising:
sending one or more threshold recommendations to the business based on the analysis.

7. The method of claim 1 further comprising:
determining a timeliness of emotive feedback of one or more shared messages initiated by the user;
generating a candidate score of the user based on a combination of the determined timeliness of emotive feedback and the class model; and
sending the request to the user based on the generated candidate score.

8. An information handling system comprising:
one or more processors;
a memory coupled to at least one of the processors;
a set of computer program instructions stored in the memory and executed by at least one of the processors in order to perform actions of:
creating a class model of a user based on analyzing a set of social media data corresponding to the user and extracted from a social media network;
matching the class model to a set of product data corresponding to a product; and
in response to matching the class model to the set of product data, sending a request to the user requesting the user to promote the product on the social media network.

9. The information handling system of claim 8 wherein, prior to creating the class model, the processors perform additional actions comprising:
capturing branding characteristics of a business corresponding to the product;
determining a set of preferred user traits corresponding to the branding characteristics; and
identifying a set of potential agents that match the set of preferred user traits, wherein the set of potential users comprises the user.

10. The information handling system of claim 9 wherein the processors perform additional actions comprising:
in response to identifying the set of potential agents, capturing a set of shared messages corresponding to the set of potential agents;
identifying a subset of the set of shared messages that correspond to the user; and
utilizing at least the subset of the shared messages as the set of social media data to create the class model.

11. The information handling system of claim 8 wherein the processors perform additional actions comprising:
receiving a response from the user agreeing to one or more terms included in the request, wherein at least one of the one or more terms is a monetary payment to the user to promote the product; and
designating the user as an agent to a business corresponding to the product.

12. The information handling system of claim 11 wherein, in response to designating the user as an agent to the business, the processors perform additional actions comprising:
collecting subsequent messages corresponding to the user;
analyzing the subsequent messages against a set of branding characteristics of the business; and
sending one or more promotion recommendations to the user based on the analysis.

13. The information handling system of claim 12 wherein the processors perform additional actions comprising:
sending one or more threshold recommendations to the business based on the analysis.

14. The information handling system of claim 8 wherein the processors perform additional actions comprising:
determining a timeliness of emotive feedback of one or more shared messages initiated by the user;
generating a candidate score of the user based on a combination of the determined timeliness of emotive feedback and the class model; and
sending the request to the user based on the generated candidate score.

15. A computer program product stored in a computer readable storage medium, comprising computer program code that, when executed by an information handling system, causes the information handling system to perform actions comprising:
creating, by the processor, a class model of a user based on analyzing a set of social media data corresponding to the user and extracted from a social media network;
matching, by the processor, the class model to a set of product data corresponding to a product; and
in response to matching the class model to the set of product data, sending, by the processor, a request to the user requesting the user to promote the product on the social media network.

16. The computer program product of claim 15 wherein, prior to creating the class model, the information handling system performs further actions comprising:
capturing branding characteristics of a business corresponding to the product;
determining a set of preferred user traits corresponding to the branding characteristics; and
identifying a set of potential agents that match the set of preferred user traits, wherein the set of potential users comprises the user.

17. The computer program product of claim 16 wherein the information handling system performs further actions comprising:
in response to identifying the set of potential agents, capturing a set of shared messages corresponding to the set of potential agents;
identifying a subset of the set of shared messages that correspond to the user; and
utilizing at least the subset of the shared messages as the set of social media data to create the class model.

18. The computer program product of claim 15 wherein the information handling system performs further actions comprising:
receiving a response from the user agreeing to one or more terms included in the request, wherein at least one of the one or more terms is a monetary payment to the user to promote the product; and
designating the user as an agent to a business corresponding to the product.

19. The computer program product of claim 18 wherein , in response to designating the user as an agent to the business, the information handling system performs further actions comprising:
collecting subsequent messages corresponding to the user;
analyzing the subsequent messages against a set of branding characteristics of the business;
sending one or more promotion recommendations to the user based on the analysis; and
sending one or more threshold recommendations to the business based on the analysis.

20. The computer program product of claim 15 wherein the information handling system performs further actions comprising:
determining a timeliness of emotive feedback of one or more shared messages initiated by the user;
generating a candidate score of the user based on a combination of the determined timeliness of emotive feedback and the class model; and
sending the request to the user based on the generated candidate score.
